(19) United States
(12) Patent Application Publication
(10) Pub. No.: US 2026/0072473 A1
(43) Pub. Date: Mar. 12, 2026

(54) TRANSPARENT LAPTOP DISPLAY WITH SELECTIVITY TO SEE REAL-WORLD OBJECTS THROUGH TRANSPARENT DISPLAY

(71) Applicant: Lenovo (United States) Inc., Morrisville, NC (US)

(72) Inventors: Robert J. Kapinos, Morrisville, NC (US); Scott Li, Morrisville, NC (US); Robert James Norton, JR., Morrisville, NC (US)

(21) Appl. No.: 18/828,889

(22) Filed: Sep. 9, 2024

(51) Int. Cl. G06F 1/16; G06F 3/01

(52) U.S. Cl. CPC G06F 1/1637; G06F 1/1616; G06F 3/012

(57) ABSTRACT

In one aspect, a laptop computer includes a processor system and storage accessible to the processor system. The storage includes instructions executable by the processor system to identify an object located behind a transparent display of the laptop computer, and to identify a user’s angle of view toward the object. The instructions are then executable to actuate the transparent display to render a first area of the display transparent according to the angle of view for the user to see the object through the first area of the transparent display. Accordingly, the transparent display can be selectively controlled by the laptop for the user to see objects through the display even though the objects are located behind the display.

### FIELD

The disclosure below relates to technically inventive, non-routine solutions that are necessarily rooted in computer technology and that produce concrete technical improvements. In particular, the disclosure below relates to transparent laptop displays that can selectively let a user see through them.

### BACKGROUND

As recognized herein, laptop computers can be technologically improved to provide more context-aware implementations, thereby giving the user a fuller and richer combined experience between the virtual world and the real world around them.

### SUMMARY

Accordingly, in one aspect a device includes a processor system and storage accessible to the processor system. The storage includes instructions executable by the processor system to identify an object located behind a transparent display of a laptop computer, where the transparent display is transitionable by the processor system between opaque and transparent. The instructions are also executable to identify a user’s angle of view toward the object, and to actuate the transparent display to render transparent a first area of the transparent display according to the angle of view for the user to see the object through the first area of the transparent display.

In example implementations, the first area may be less than an entire area of the transparent display that is transitionable between opaque and transparent.

Also in some example implementations, the instructions may be executable to identify a head pose of the user to identify the angle of view. Additionally, if desired the instructions may be executable to execute whiteboard detection software to identify the object as one for which to make transparent a portion of the transparent display.

What’s more, in some example implementations the instructions may be executable to use vector math to identify the angle of view, and to present the first area to account for keystone distortion and to account for user parallax in the horizontal axis. In some non-limiting examples, the first area may therefore be controlled by the processor system to be trapezoid-shaped to account for the keystone distortion.

What’s more, if desired the instructions may be executable to receive user input to the laptop computer that is directed to the first area and, based on identifying the user input as being directed to the first area, decline to execute a function based on the user input. This can help reduce false positives for user input.

Additionally, in some examples the instructions may be executable to receive input from a first sensor directed away from on a first surface of the transparent display, and to identify the object based on the input from the first sensor. If desired, the instructions may be further executable to receive input from a second sensor directed away from a second surface of the transparent display, and to identify the angle of view based on the input from the second sensor.

In various examples, the object may be identified for viewing through the transparent display based on the object being a predetermined object such as a television, a whiteboard, a wall, and/or another display other than the transparent display itself.

Also in some embodiments, the device may include the laptop computer.

In another aspect, a method includes identifying an object located behind a transparent display of a laptop computer. The transparent display itself is transitionable between opaque and transparent. The method also includes identifying a user’s angle of view toward the object. The method then includes actuating the transparent display to render a first area of the transparent display transparent according to the angle of view for the user to see the object through the first area of the transparent display.

In some examples, the method may specifically include identifying a head pose of the user to identify the angle of view. If desired, the method may further include executing whiteboard detection software to identify the object as one for which to make transparent a portion of the transparent display, as well as presenting the first area to account for keystone distortion and to account for user parallax.

In still another aspect, at least one computer readable storage medium (CRSM) that is not a transitory signal includes instructions. The instructions are executable by a processor system to identify an object located behind a transparent display, with the transparent display being transitionable by the processor system between opaque and transparent. The instructions are also executable to identify a user’s angle of view toward the object, and to actuate the transparent display to render a first area of the transparent display transparent according to the angle of view for the user to see the object through the first area of the transparent display.

In some instances, the instructions may also be executable to use a first sensor to identify a head pose of the user to then identify the angle of view, and to use a second sensor to identify the object as one for which to make transparent a portion of the transparent display. The second sensor may be different from the first sensor.

What’s more, if desired the instructions may be executable to execute augmented reality (AR) software to present virtual content at the first area for the virtual content to appear as though disposed on the object.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a front view of a display panel of a laptop computer consistent with present principles;

FIG. 3 is a rear view of the display panel of the laptop computer consistent with present principles;

FIG. 4 shows a portion of the laptop computer’s transparent display being rendered transmissive for viewing a real-world object beyond the display through the display itself consistent with present principles;

FIG. 5 shows the transparent display being controlled to render an AR object in the transmissive area for the AR object to appear as though located on the real-world object itself;

FIG. 6 illustrates example logic in example flow chart format that may be executed by a device consistent with present principles;

FIG. 7 shows a schematic of a user looking at a white board beyond a transparent laptop display to illustrate de-keystoning and de-parallaxing consistent with present principles; and

FIG. 8 shows an example settings graphical user interface (GUI) that may be presented to configure one or more settings of a device to operate consistent with present principles.

### DETAILED DESCRIPTION

Present principles deal in part with transparent laptop displays, such as transparent organic light-emitting diode (OLED) displays. A laptop operating consistent with present principles may therefore combine whiteboard detection and user head pose detection with transparent screen technology to provide a not-quite AR experience, or “inverted” AR experience if you will.

Accordingly, rear sensors on the laptop can discover, using whiteboard detection, that there is an overlayable screen or board behind the laptop’s own screen. The laptop can then calculate the user’s viewing angles to determine the visible overlapping portions of the whiteboard that the user can see through the transparent laptop screen. That area of the laptop screen can then be cleared of other content, except maybe as used for digital overlays onto the real-world whiteboard surface itself. Digital overlays can be items the user positions in the cleared (transmissive) area, items drawn directly onto the screen, items put there by apps coordinating with the whiteboard (e.g. Amazon Prime X-Ray), or items sent by collaborational apps.

Therefore, as the user moves his head or the laptop itself, the onscreen position of the whiteboard (transmissive) region and the digital AR overlays are recalculated and redrawn according to the new angle of view. Thus, the laptop can calculate both the user head pose and whiteboard location together to draw on a third screen with correctly-positioned overlays. The software to undertake these principles may be located in middleware or at the UX level, for example.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/ or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java^{®}/JavaScript, C# or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein.

"A system having at least one of A, B, and C" (likewise "a system having at least one of A, B, or C" and "a system having at least one of A, B, C") includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

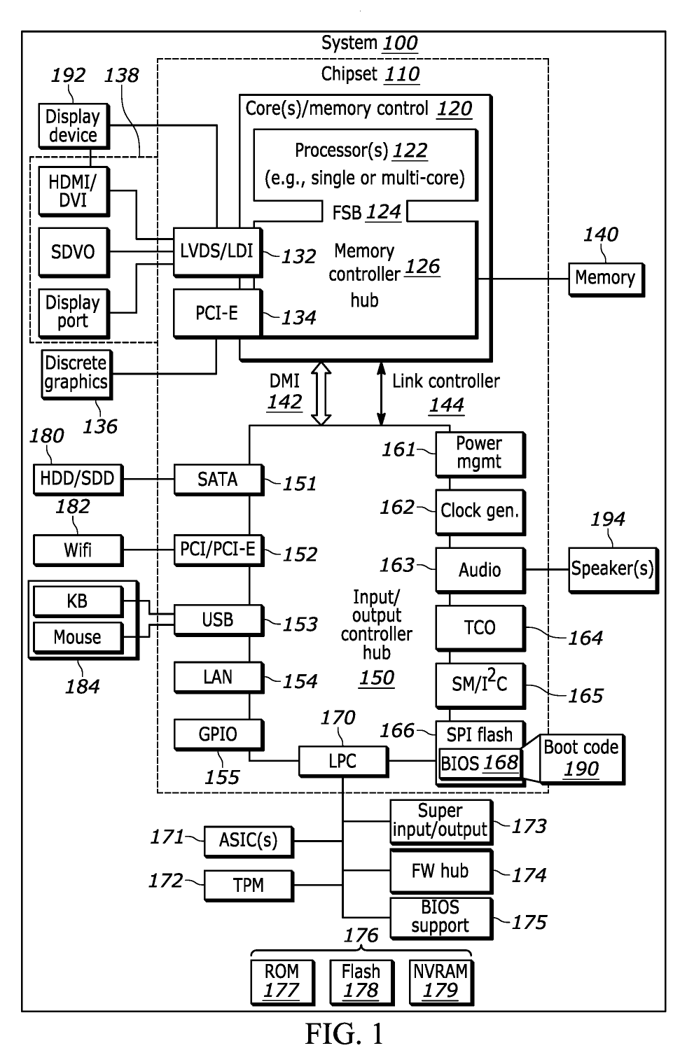

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one or more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122.

Still further, the system 100 may include an audio receiver/microphone that provides input from the microphone to the processor system 122 based on audio that is detected, such as via a user providing audible input to the microphone.

The system 100 may also include a camera that gathers one or more images and provides the images and related input (e.g., metadata like an image timestamp) to the processor system 122. The camera may be a thermal imaging camera, an infrared (IR) camera, a digital camera such as a webcam, a three-dimensional (3D) camera, and/or a camera otherwise integrated into the system 100 and controllable by the processor system 122 to gather still images and/or video.

Also, the system 100 may include a global positioning system (GPS) transceiver that is configured to communicate with satellites to receive/identify geographic position information and provide the geographic position information to the processor system 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

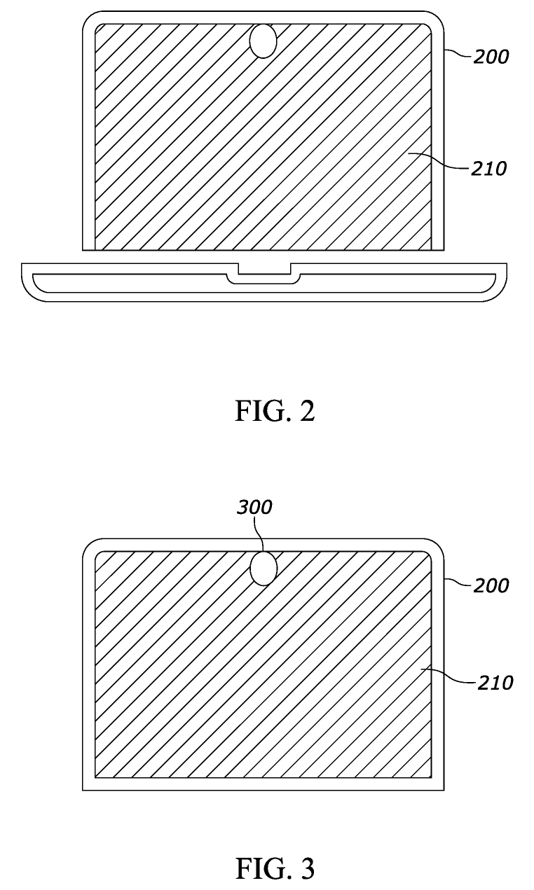

Turning now to FIG. 2, a front view is shown of an example laptop computer 200 with transparent display 210. The transparent display 210 may be a transparent organic light emitting diode (OLED) display or another type of external light-transmissive display. The laptop computer 200 may also include a front sensor 220 on the front face/side of the display 210, with the sensor 220 directed externally away from that side. The sensor 220 may be one capable of use for head pose detection and, as such, may be a three dimensional (3D) camera, a laser rangefinder, an ultrasonic transceiver, a radar transceiver, a red-green-blue (RGB) camera, or other suitable sensor.

FIG. 3 then shows a rear view of the laptop computer 200. Note here that a rear (second) sensor 300 is shown disposed on the rear face/side of the display 210, with the sensor 300 directed externally away from the rear side. Thus, the second sensor 300 may generally be directed in an opposite direction as the first sensor 220 even though they may both have a relatively wide field of view away from their respective surfaces. The sensor 300 itself may be one capable of use for whiteboard detection and, as such, may be a digital camera or other suitable sensor.

It may therefore be appreciated based on FIGS. 2 and 3 that the front sensor 220 may be used to identify a user’s angle of view toward an object that can be seen through the transparent display 210, with the rear sensor 300 being used to identify the object itself for mapping to the angle of view. The laptop computer 200 may thus selectively control a small area of the display 210 to be light transmissive, while possibly presenting digital content and other opaque graphics on other portions of the display 210 (hence those portions not being transmissive). This may be done so that the user can see the real-world object itself on the other side of the display through the transmissive area while still allowing the user to see digital content in tandem.

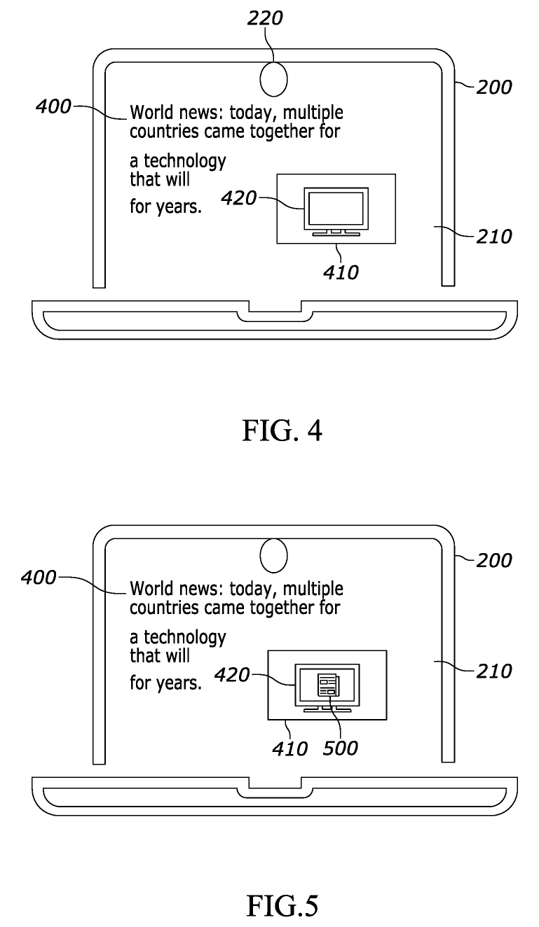

FIG. 4 further illustrates. Digital content 400 is shown as being presented on selectively non-transparent portions of the display 210 while a smaller area 410 of the display 210 has been actuated into a transmissive state so that the user can see a real-world television 420 in real-world 3D space behind the display 210. Note here that part of the content 400 has been cut off and dropped from rendering to make room for the area 410, with the full phrase of the content 400 being “World News: Today, multiple countries came together for a technology treaty that will have impacts for years,” with “treaty” and “have impacts” being removed from rendering to make room for the area 410.

FIG. 5 then shows that in some examples, augmented reality (AR) software or other extended reality (XR) software may be executed to present a digital, graphical icon 500 on the display 210 for the icon 500 to appear as though it was actually located in 3D space as presented on the real-world TV 420 itself.

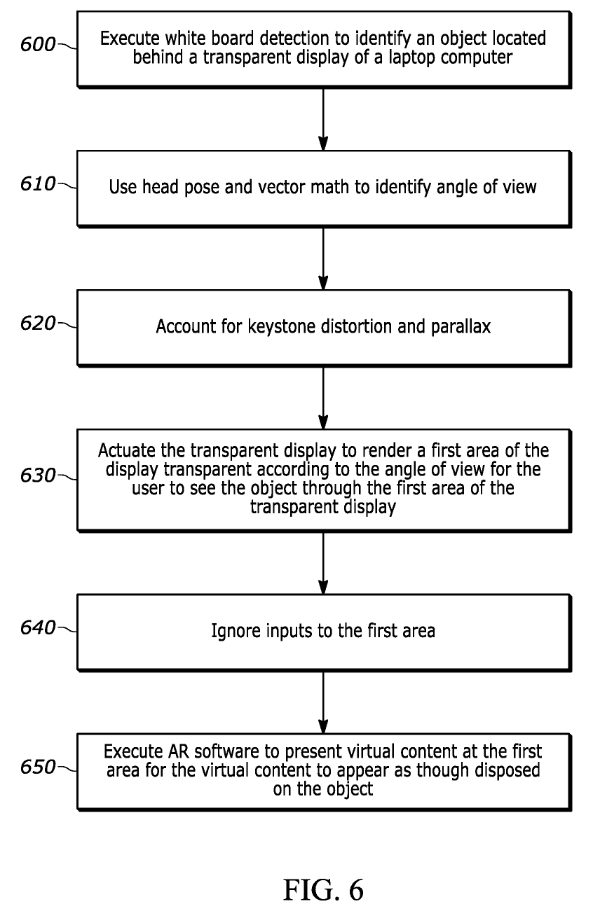

Now in reference to FIG. 6, this figure shows example logic that may be executed by a device such as the system 100 and/or a laptop computer consistent with present principles. Note that while the logic of FIG. 6 is shown in flow chart format, other suitable logic may also be used.

Beginning at block 600, the device may receive input from the rear sensor 300 to identify an object located behind the transparent display of the laptop computer. Note that the transparent display may be transitionable between opaque and transparent and, as such, may be a transparent OLED in example embodiments.

To identify the object at block 600, whiteboard detection and/or other forms of objection recognition may be executed to identify predetermined objects in the user’s environment that the laptop computer should make viewable through its transparent display. The predetermined objects may include, but are not limited to, a television, a whiteboard, a wall, and another display other than the laptop’s own transparent display (e.g., another computer monitor).

From block 600 the logic may proceed to block 610. At block 610 the device may receive input from the front sensor 220 to identify a head pose of the user while the user is in front of the transparent display. Vector math may then be executed by the laptop computer using the head pose data to identify the user’s angle of view toward the recognized real-world object behind the transparent display.

From block 610 the logic may then proceed to block 620. At block 620 the device may, to determine a size and shape of a “first area” of the transparent display to make transparent, account for keystone distortion and user parallax in the horizontal axis. Thus, at block 620 the device may execute keystone correction for the identified object based on an identified amount of keystone distortion for that object, with it being recognized that in the real world the object behind the display will likely not be completely square to the display itself. Thus, the first area that is cleared of content (so that the user can view the object) might be trapezoid in shape rather than rectangular, even if the real-world object itself were something like a rectangular TV. Note that in one particular example, the rear sensor 300 may be a camera, and here the laptop computer may therefore execute computer vision using images from the camera to identify the keystone distortion via the identified shape and orientation of the object in 3D space as well as its distance from the laptop computer.

Also at block 620 and as mentioned above, de-parallaxing may executed by the laptop computer. The first area that establishes the transmissive “hole” in the display may therefore be adjusted in size through additive math so that neither of the user’s eyes have obscuration at the edges of the first area in relation to the object itself. To de-parallax, the laptop may therefore add different determined screen locations for the first area together, with the different screen locations being determined from the different angles of view of each eye toward the object, to then use the resulting cumulative screen location as the first area. Thus, the first area of the display may be larger in the horizontal dimension than if the user were looking at the object in a monocular way (with a monocular angle of view). This helps ensure a clear line of sight to the object from each eye.

Accordingly, in one particular example, the first area as determined at block 620 may be trapezoid-shaped to account for the keystone distortion, and larger in the horizontal dimension to account for user parallax.

From block 620 the logic of FIG. 6 may continue to block 630. At block 630 the device may actually actuate the transparent display to render the first area of the display transparent according to the angle(s) of view for the user to see the object through the first area of the transparent display. To reiterate, the first area may be less than an entire area of the transparent display that is transitionable between opaque and transparent, with the first area being rendered transparent to create a viewing “hole” to see the real-world object beyond the display (with other areas of the display possibly remaining opaque).

After block 630 the logic may proceed to block 640. At block 640 the device may receive user input that is directed to the first area itself. Based on identifying the user input as being directed to the first area, the device may then decline to execute a function based on that input. So, for example, the user might use the laptop’s track pad to position the on-screen cursor within the first area, and then submit a left-click command by accident. Therefore, so that the laptop computer does not otherwise translate that user action into a command on which to act, the laptop may instead ignore the input to the first area. Thus, a menu or other item that might otherwise pop up onscreen at the first area will not do so, avoiding annoying the user and obstructing the user’s view toward the object.

After block 640 the logic may proceed to block 650. At block 650 the device may, if desired, execute augmented reality (AR) software to present virtual content at the first area for the virtual content to appear as though disposed in 3D space on the object itself. As an example, recall the description of FIG. 5 above, where the icon 500 was presented on the transparent display to appear as though disposed on the TV 420 at the real-world location of the TV 420.

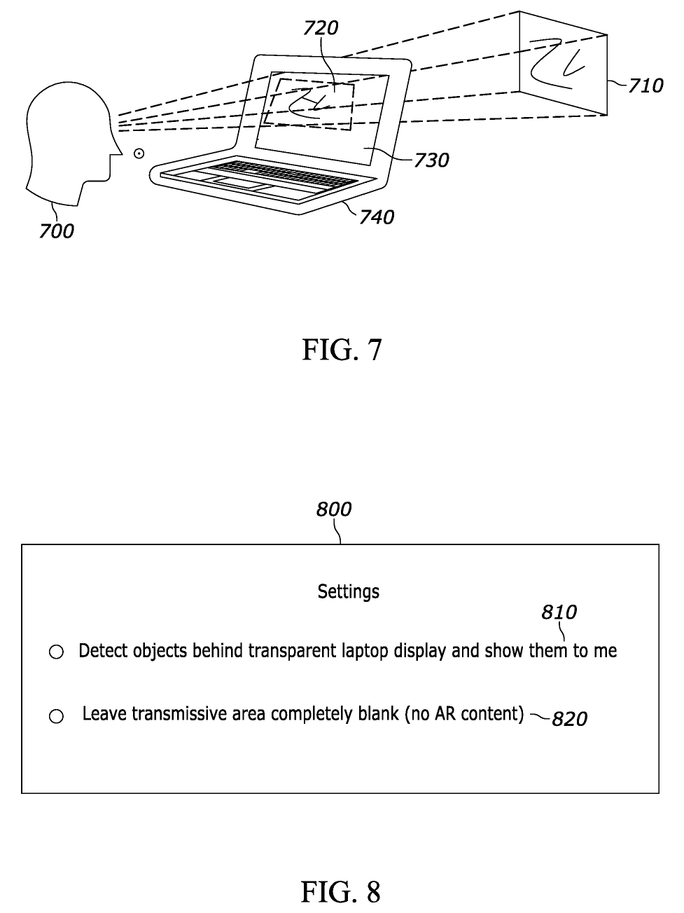

To further illustrate de-keystoning (keystone correction) and de-parallaxing, refer now to FIG. 7. This figure shows a schematic of a user 700 viewing a real-world whiteboard 710 through a transmissive area 720 of a transparent display 730 of a laptop computer 740. Owing to the plane of the whiteboard 710 not being parallel to the plane of the transparent display 730, keystone distortion is accounted for in the area 720, with the laptop making the area 720 trapezoidal in shape so that all portions of the whiteboard 710 are visible through the display 710 while still leaving as much of the rest of the display 710 as possible opaque. And owing to the different angles of view to the whiteboard 710 from each of the user’s eyes as also illustrated in FIG. 7, the area 720 is rendered wide enough in the horizontal dimension so that all of the whiteboard 710 is viewable through the transmissive area 720 by each of the user’s eyes notwithstanding parallax.

Continuing the detailed description in reference to FIG. 8, this figure shows an example GUI 800 that may be presented on a display for an end-user to configure one or more settings of a laptop or software application (“app”) to operate consistent with present principles. As shown, the GUI 800 may include a first option 810 that is selectable to set or enable the laptop computer to detect objects behind the laptop’s transparent display to let the user see them through the laptop’s transparent display. Thus, for example, selection of the option 810 may set or configure the laptop to perform the functions described above in reference to FIGS. 2-7.

As also shown in FIG. 8, the GUI 800 may include a sub-option 820. The sub-option 820 may be selected to set or enable the laptop to refrain from presenting AR content inside of selectively transmissive areas to leave the user’s view through the transmissive area completely unobstructed.

Moving on from FIG. 8, it is to be understood that while laptop computers have been discussed at various points above, present principles are not limited to laptop computers. Indeed, present principles may be implemented for any client device with a transparent display so that content can be presented on the display while also controlling a small area of the display to be in a transmissive state to allow the user to see through and past the transparent display.

Components included in one embodiment can be used in other embodiments in any appropriate combination. For example, any of the various components described herein and/or depicted in the Figures may be combined, interchanged or excluded from other embodiments.

It is to be understood that whilst present principals have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. A device, comprising:
a processor system; and
storage accessible to the processor system and comprising instructions executable by the processor system to:
identify an object located behind a transparent display of a laptop computer, the transparent display being transitionable by the processor system between opaque and transparent;
identify a user’s angle of view toward the object; and
actuate the transparent display to render a first area of the transparent display transparent according to the angle of view for the user to see the object through the first area of the transparent display.

2. The device of claim 1, wherein the first area is less than an entire area of the transparent display that is transitionable between opaque and transparent.

3. The device of claim 1, wherein the instructions are executable to:
identify a head pose of the user to identify the angle of view.

4. The device of claim 1, wherein the instructions are executable to:
execute whiteboard detection software to identify the object as one for which to make transparent a portion of the transparent display.

55 The device of claim 1, wherein the instructions are executable to:
use vector math to identify the angle of view.

6. The device of claim 5, wherein the instructions are executable to:
present the first area to account for keystone distortion.

7. The device of claim 6, wherein the first area is controlled by the processor system to be trapezoid-shaped to account for the keystone distortion.

8. The device of claim 6, wherein the instructions are executable to:
present the first area to account for user parallax in the horizontal axis.

9. The device of claim 1, wherein the instructions are executable to:
receive user input to the laptop computer that is directed to the first area; and
based on identifying the user input as being directed to the first area, decline to execute a function based on the user input.

10. The device of claim 1, wherein the instructions are executable to:
receive input from a first sensor directed away from on a first surface of the transparent display; and
identify the object based on the input from the first sensor.

11. The device of claim 10, wherein the instructions are executable to:
receive input from a second sensor directed away from a second surface of the transparent display; and
identify the angle of view based on the input from the second sensor.

12. The device of claim 1, wherein the object is identified for viewing through the transparent display based on the object being a predetermined object selected from the group consistent of: a television, a whiteboard, a wall, another display other than the transparent display.

13. The device of claim 1, comprising the laptop computer.

14. A method, comprising:
identifying an object located behind a transparent display of a laptop computer, the transparent display being transitionable between opaque and transparent;
identifying a user’s angle of view toward the object; and
actuating the transparent display to render a first area of the transparent display transparent according to the angle of view for the user to see the object through the first area of the transparent display.

15. The method of claim 14, comprising:
identifying a head pose of the user to identify the angle of view.

16. The method of claim 14, comprising:
executing whiteboard detection software to identify the object as one for which to make transparent a portion of the transparent display.

17. The method of claim 14, comprising:
presenting the first area to account for keystone distortion and to account for user parallax.

18. At least one computer readable storage medium (CRSM) that is not a transitory signal, the at least one CRSM comprising instructions executable by a processor system to:
identify an object located behind a transparent display, the transparent display being transitionable by the processor system between opaque and transparent;
identify a user’s angle of view toward the object; and
actuate the transparent display to render a first area of the transparent display transparent according to the angle of view for the user to see the object through the first area of the transparent display.

19. The at least one CRSM of claim 18, wherein the instructions are executable to:
use a first sensor to identify a head pose of the user to identify the angle of view; and
use a second sensor to identify the object as one for which to make transparent a portion of the transparent display, the second sensor being different from the first sensor.

20. The at least one CRSM of claim 18, wherein the instructions are executable to:
execute augmented reality (AR) software to present virtual content at the first area for the virtual content to appear as though disposed on the object.
